(19) United States
(12) Patent Application Publication
(10) Pub. No.: US 2012/0218670 A1
(43) Pub. Date: Aug. 30, 2012

(54) POWER SUPPLY DEVICE HAVING OVERVOLTAGE PROTECTION FUNCTION

(75) Inventor: Seung Ho HAN, Suwon (KR)

(73) Assignee: SAMSUNG ELECTRO-MECHANICS CO., LTD.

(21) Appl. No.: 13/109,487

(22) Filed: May 17, 2011

(30) Foreign Application Priority Data
Feb. 28, 2011 (KR) 10-2011-0017852

(51) Int. Cl. H02H 3/20

(52) U.S. Cl. 361/18

(57) ABSTRACT

There is provided a power supply device having an overvoltage protection function against an overvoltage caused by a lightning strike, a power surge, or the like. The power supply device having an overvoltage protection function includes: a power supply unit inverting input power to supply driving power; a controller controlling an inverting operation of the power supply unit in response to an external control signal; and a protection unit interrupting the control signal provided to the controller to stop the inverting operation of the power supply unit when a voltage level of the input power is equal to a pre-set voltage level or higher.

### CROSS-REFERENCE TO RELATED APPLICATIONS

This application claims the priority of Korean Patent Application No. 10-2011-0017852 filed on Feb. 28, 2011, in the Korean Intellectual Property Office, the disclosure of which is incorporated herein by reference.

### BACKGROUND OF THE INVENTION

1. Field of the Invention

The present invention relates to a power supply device having an overvoltage protection function with respect to an overvoltage caused by a lightning strike, a power surge, or the like.

2. Description of the Related Art

In general, electronic devices used by individuals in homes, offices, and the like employ a power conversion device for converting mains power into driving power required by the electronic devices and supplying the converted driving power to the electronic devices.

Such a power conversion device undergoes various tests in safety standards to allow users to stably or reliably use it both domestically and internationally. The tests include a mechanical test, an electrical test, or the like, and the electrical test includes a power surge test executed in preparation for an occurrence of an abnormal situation such as that caused by a lightning strike.

Meanwhile, among existing cathode ray tube (CRT) display devices, a flat panel display device is largely used owing to advantages such as being lightweight, thin, short, and small. The flat panel display device employs a power supply device for supplying driving power to a lamp, and in this case, the power supply device may undergo a power surge test.

The foregoing power supply device supplies lamp driving power by inverting input power, and in this case, when an overvoltage is input thereto in an abnormal state, such as a power surge test or a lightning strike, the voltage level of input power increases to increase the current input to a main switch for an inverting operation, breaking down the insulation of the main switch.

### SUMMARY OF THE INVENTION

An aspect of the present invention provides a power supply device having an overvoltage protection function capable of stopping an operation of an inverting control circuit when an overvoltage is input, thus preventing an introduction of an overcurrent to a main switch.

According to an aspect of the present invention, there is provided a power supply device having an overvoltage protection function, including: a power supply unit inverting input power to supply driving power; a controller controlling an inverting operation of the power supply unit in response to an external control signal; and a protection unit interrupting the control signal provided to the controller to stop the inverting operation of the power supply unit when a voltage level of the input power is equal to a pre-set voltage level or higher.

The protection unit may include: a voltage-dividing resistor group for dividing voltage of the input power; a comparison unit comparing the level of the divided voltage with a pre-set reference voltage level; and a bypass unit bypassing the control signal provided to the controller to a ground when the voltage level of the input power is equal to the pre-set voltage level or higher according to the comparison results.

The bypass unit may have a photocoupler.

The photocoupler may include: a light emitting diode (LED) having an anode connected to an operation power terminal supplying pre-set operation power and a cathode connected to the comparison unit; and a phototransistor connected between a signal input terminal, to which the control signal is input, and a ground, and turned on or off in response to an electrical signal from the LED.

The controller may include: an inverter controller providing an inverter control signal for controlling an inverting operation of the power supply unit when the control signal has a high voltage level, and stopping the operation of providing the inverter control signal to the power supply unit when the control signal has a low voltage level; and a transmission transformer having a primary coil (or a winding coil) receiving the inverter control signal and a secondary coil insulated from the primary coil and electromagnetically coupled to the primary coil to transfer the inverter control signal to the power supply unit.

The power supply unit may include an inverter unit including, the inverter unit having a switching circuit switching the input power in response to the inverter control signal; and a first transformer having a primary coil receiving power switched by the switching circuit and a secondary coil insulated from the primary coil and electromagnetically coupled to the primary coil to output lamp driving power.

The power supply unit may further include: a filter unit filtering electromagnetic interference from commercial AC power; a rectifying unit rectifying and smoothing filtered power from the filter unit; and a power factor correction unit correcting a power factor of the rectified and smoothed power from the rectifying unit and providing the input power.

The power supply unit may further include: a converter unit including a flyback controller switching the input power and a second transformer having a primary coil receiving the switched power and a secondary coil insulated from the primary coil and electromagnetically coupled to the primary coil to output multiple powers; and a rectifying/smoothing unit rectifying and smoothing the multiple powers from the converter unit to output stabilized power.

The power supply unit may have a primary ground side and a secondary ground side each having a different ground potential level, wherein the filter unit, the rectifying unit, the power factor correction unit, the switching circuit and the primary coil of the first transformer of the inverter unit, the flyback controller and the primary coil of the second transformer of the converter unit, a voltage-dividing resistor of the protection unit, the comparison unit and the LED of the photocoupler, and the secondary coil of the transmission transformer of the controller are formed at the primary ground side, and the phototransistor of the photocoupler, the inverter controller and the primary coil of the transmission transformer, the secondary coil of the first transformer, the secondary coil of the second transformer, and the rectifying/smoothing unit are formed at the secondary ground side.

The inverter controller may provide an inverter control signal for switching the switching circuit on and off according to a fixed ON/OFF duty, and the inverter unit may control the current level of the lamp driving power according to resonance between the inductance of the first transformer, and leakage capacitance and resonant capacitance of a lamp.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a power supply device according to an exemplary embodiment of the present invention; and

FIG. 2 is a schematic circuit diagram of the power supply device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

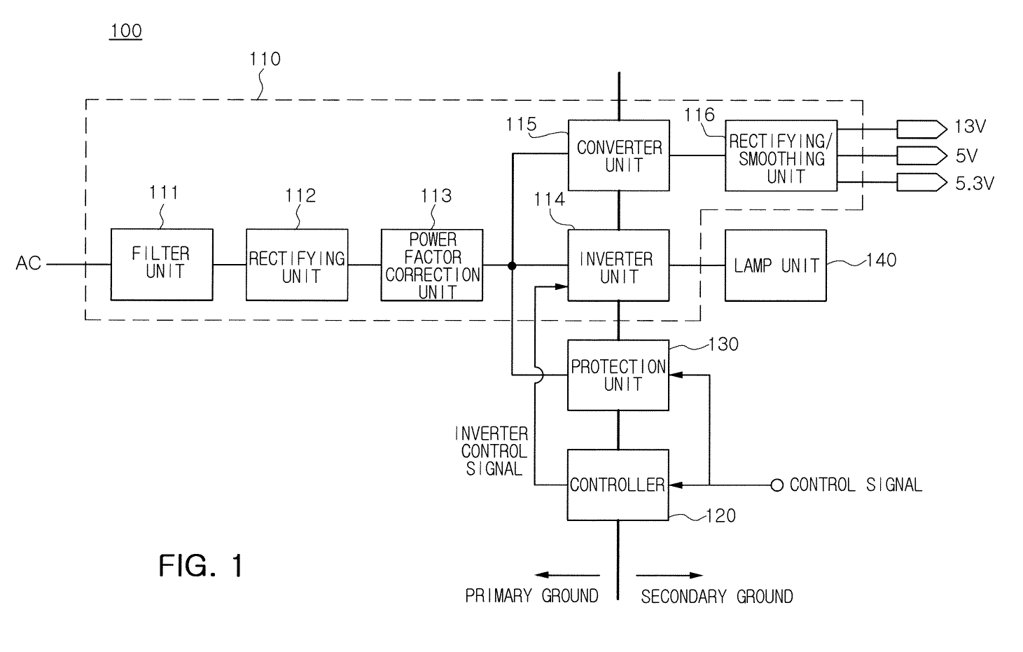

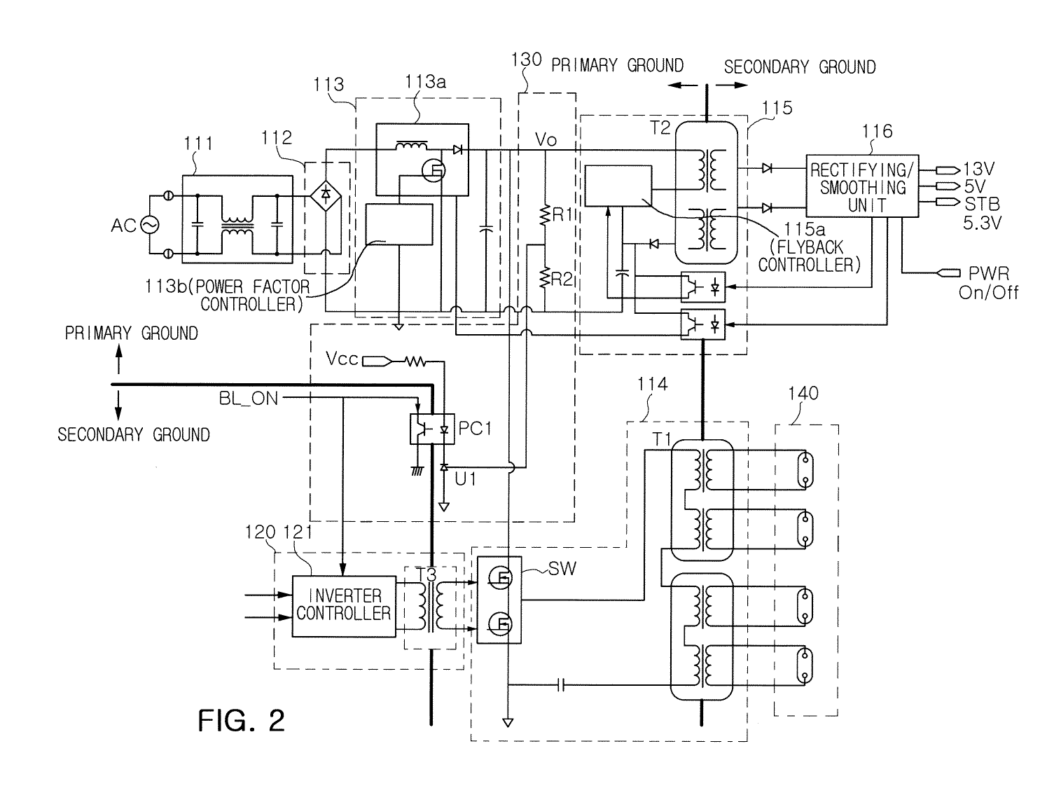

FIG. 1 is a schematic block diagram of a power supply device according to an exemplary embodiment of the present invention, and FIG. 2 is a schematic circuit diagram of the power supply device according to an exemplary embodiment of the present invention.

With reference to FIGS. 1 and 2, a power supply device 100 according to an exemplary embodiment of the present invention may include a power supply unit 110, a controller 120, and a protection unit 130.

The power supply unit 110 may include a filter unit 111 filtering electromagnetic interference (EMI) from commercial AC power, a rectifying unit 112 rectifying and smoothing the filtered power, a power factor correction unit 113 calibrating a phase difference between the voltage and current of the rectified power to correct a power factor, an inverter unit 114 inverting the power factor-corrected power to supply lamp driving power, a converter unit 115 converting the power factor-corrected power in a flyback manner to supply multiple powers, and a rectifying/smoothing unit 116 rectifying and smoothing the multiple powers to stabilize them.

The filter unit 111 may include a capacitor disposed between a live terminal and a neutral terminal of a commercial AC power source and an inductor disposed on each of a live terminal line and a neutral terminal line.

The rectifying unit 112 may include at least one bridge diode.

The power factor correction unit 113 may include an inductor for accumulating and discharging electricity of the rectified power, a power factor correction circuit 113a having a switch for switching power which is accumulated in and discharged from the inductor, and a power factor correction controller 113b for controlling the switching operation.

The inverter unit 114 may include a switching circuit SW for switching the power factor-corrected power, and a first transformer T1 that has a primary coil receiving switched power and a secondary coil insulated from the primary coil and electromagnetically coupled to the primary coil to supply the lamp driving power to each lamp of the lamp unit 140 according to a corresponding winding ratio. The switching circuit SW may be variably configured. Namely, it may be configured as a half bridge having at least two switches, a full bridge having at least four switches, or the like. Each lamp of the lamp unit 140 may be a cold cathode fluorescent lamp (CCFL). Each lamp may have leakage capacitance, and the inverter unit 114 may control a current level of the lamp driving power by a resonance tank formed by resonance among the inductance of the first transformer T1, and resonance capacitance and the leakage capacitance of each lamp.

The converter unit 115 may include a flyback controller 115a switching the power factor-corrected power in a flyback manner to perform DC/DC conversion on the power, and a second transformer T2 having a primary coil receiving the converted power and a secondary coil insulated from the primary coil and electromagnetically coupled to the primary coil to output multiple powers according to a corresponding winding ratio.

The rectifying/smoothing unit 116 may rectify and smooth the multiple powers from the converter unit 115 to stabilize the same, and output multiple powers having voltages of 13V, 5V, and 5.3V. The multiple powers may be supplied to an image circuit, a driving circuit, a standby circuit (not shown), or the like, of a display device.

The controller 120 may provide an inverter control signal for controlling an inverting operation of the inverter unit 114. The controller 120 may include an inverter controller 121 and a transmission transformer T3.

When a control signal BL_ON from the exterior is a high level signal having a pre-set voltage level, the inverter controller 121 may provide an inverter control signal for controlling an ON/OFF switching operation of a plurality of switches of the switching circuit SW of the inverter unit 114, and when the control signal BL_ON from the exterior is a low level signal having a voltage level lower than that of the high level signal, the inverter controller 121 may stop the operation of providing the inverter control signal.

The transmission transformer T3 may have a primary coil receiving the inverter control signal and a secondary coil insulated from the primary coil and transferring the inverter control signal from the primary coil to the switching circuit SW.

The protection unit 130 may include voltage-dividing resistors R1 and R2, a comparison unit U1, and a bypass unit PC1.

The voltage-dividing resistors R1 and R2, having a pre-set resistance ratio, may divide the voltage of the power factor-corrected power from the power factor correction unit 113.

The comparison unit U1, which may be configured as a shunt regulator such as TL431, or the like, may compare the divided voltage with a reference voltage having a pre-set voltage level.

The bypass unit PC1 may be configured as a photocoupler PC1. The photocoupler PC1 may include a light emitting diode (LED) PC1-1 having an anode receiving pre-set operation power Vcc and a cathode connected to the comparison unit U1, and a phototransistor PC1-2 insulated from the LED PC1-1 and connected between a control signal input terminal to which the control signal BL_ON is input and a ground.

The power supply unit 110 may have a primary ground side and a secondary ground side each having a different ground potential level. In the power supply unit 110, the filter unit 111, the rectifying unit 112, the power factor correction unit 113, the switching circuit SW and the primary coil of the first transformer T1 of the inverter unit 114, the flyback controller 115a and the primary coil of the second transformer T2 of the converter unit 115, the voltage-dividing resistors R1 and R2, the comparison unit U1, and the LED PC1-1 of the photocoupler PC1 of the protection unit 130, and the secondary coil of the transmission transformer T3 of the controller 120 maybe formed at the primary ground side, and the phototransistor PC1-2 of the photocoupler PC1, the inverter controller 121 and the primary coil of the transmission transformer T3, the secondary coil of the first transformer T1, the secondary coil of the second transformer T2, and the rectifying/smoothing unit 116 may be formed at the secondary ground side.

Meanwhile, an overvoltage may be applied to the commercial AC power due to a lightning strike, a power surge test, or the like.

Namely, when the commercial AC power is input, the input commercial AC power is rectified and smoothed, and thereafter, the power factor correction unit 113 may output power factor-corrected DC power and the converter unit 115 may perform a DC/DC conversion operation and the rectifying/smoothing unit 116 may output a plurality of DC powers. Among the plurality of DC powers from the rectifying/smoothing unit 116, a DC power having a voltage level of 13V may be supplied to an inverter controller 121.

When the control signal BL_ON from the exterior is a high level signal having a pre-set voltage level, the inverter controller 121 may provide an inverter control signal for controlling an ON/OFF switching operation of a plurality of switches of the switching circuit SW of the inverter unit 114, and the inverter unit 114 may perform a DC/AC conversion operation to output lamp driving power. In this case, if an overvoltage is applied to an input terminal to which the commercial AC power is input, the voltage level of the power factor-corrected power of the power factor correction unit 113 may be instantly increased. In this case, since the inverter controller 121 provides an inverter control signal enabling the switching circuit SW of the inverter unit 114 to be switched on or off according to a fixed ON/OFF duty, the current of a resonance tank of the inverter unit 114 is increased, and in this case, the resonance current maybe increased to have a level sufficiently high as to break down the insulation of the switching circuit SW.

Meanwhile, the voltage-dividing resistors R1 and R2 may divide the voltage level of the power factor-corrected power increased according to a pre-set voltage division ratio. The comparison unit U1 may compare the divided voltage level of the power factor-corrected power with a voltage level of a pre-set reference voltage. The LED PC1-1 of the photocoupler PC1 may emit light according to the comparison result from the comparison unit U1 and transfer an optical signal to the phototransistor PC1-2. Namely, when an overvoltage having a pre-set voltage level or higher is applied, the LED PC1-1 may transfer the optical signal to turn on the phototransistor PC1-2, and the turned-on phototransistor PC1-2 may bypass the control signal BL_ON to the ground, preventing the control signal BL_ON from being delivered to the inverter controller 121.

Accordingly, the inverter controller 121 may stop the providing of the inverter control signal, and thus, the switching circuit SW may stop its switching operation. Accordingly, an overcurrent otherwise applied by an overvoltage when the switching circuit SW operates can be prevented.

When the voltage level of the power output from the power factor correction unit 113 is dropped to a pre-set level or below, the inverter controller 121 can provide the inverter control signal normally, and also, the inverter controller 121 can provide the inverter control signal normally through a reset process in which it is re-started after completely cutting off power.

As set forth above, according to exemplary embodiments of the invention, when an overvoltage is input to a power input terminal, to which commercial AC power is to be input, due to a lightning strike, a power surge test, or the like, to increase power, whose power factor has been corrected by the power factor correction circuit, to a reference level or higher; an inverting operation is interrupted, thus preventing an insulation breakdown of a main switch for performing the inverting operation.

While the present invention has been shown and described in connection with the exemplary embodiments, it will be apparent to those skilled in the art that modifications and variations can be made without departing from the spirit and scope of the invention as defined by the appended claims.

What is claimed is:

1. A power supply device having an overvoltage protection function, the device comprising:
a power supply unit inverting input power to supply driving power;
a controller controlling an inverting operation of the power supply unit in response to an external control signal; and
a protection unit interrupting the control signal provided to the controller to stop the inverting operation of the power supply unit when a voltage level of the input power is equal to a pre-set voltage level or higher.

2. The device of claim 1, wherein the protection unit includes:
a voltage-dividing resistor group for dividing voltage of the input power;
a comparison unit comparing the level of the divided voltage with a pre-set reference voltage level; and
a bypass unit bypassing the control signal provided to the controller to a ground when the voltage level of the input power is equal to the pre-set voltage level or higher according to the comparison results.

3. The device of claim 2, wherein the bypass unit has a photocoupler.

4. The device of claim 3, wherein the photocoupler includes:
a light emitting diode (LED) having an anode connected to an operation power terminal supplying pre-set operation power and a cathode connected to the comparison unit; and
a phototransistor connected between a signal input terminal, to which the control signal is input, and a ground, and turned on or off in response to an electrical signal from the LED.

5. The device of claim 1, wherein the controller includes:
an inverter controller providing an inverter control signal for controlling the inverting operation of the power supply unit when the control signal has a high voltage level, and stopping the operation of providing the inverter control signal to the power supply unit when the control signal has a low voltage level; and
a transmission transformer having a primary coil receiving the inverter control signal and a secondary coil insulated from the primary coil and electromagnetically coupled to the primary coil to transfer the inverter control signal to the power supply unit.

6. The device of claim 5, wherein the power supply unit includes an inverter unit, the inverter unit having:
a switching circuit switching the input power in response to the inverter control signal; and
a first transformer having a primary coil receiving power switched by the switching circuit and a secondary coil insulated from the primary coil and electromagnetically coupled to the primary coil to output lamp driving power.

7. The device of claim 6, wherein the power supply unit further includes:
a filter unit filtering electromagnetic interference from commercial AC power;
a rectifying unit rectifying and smoothing filtered power from the filter unit; and
a power factor correction unit correcting a power factor of the rectified and smoothed power from the rectifying unit and providing the input power.

8. The device of claim 7, wherein the power supply unit further includes:
a converter unit including a flyback controller switching the input power and a second transformer having a primary coil receiving the switched power and a secondary coil insulated from the primary coil and electromagnetically coupled to the primary coil to output multiple powers; and
a rectifying/smoothing unit rectifying and smoothing the multiple powers from the converter unit to output stabilized power.

9. The device of claim 4, wherein the power supply unit has a primary ground side and a secondary ground side each having a different ground potential level,
wherein the filter unit, the rectifying unit, the power factor correction unit, the switching circuit and the primary coil of the first transformer of the inverter unit, the flyback controller and the primary coil of the second transformer of the converter unit, a voltage-dividing resistor, the comparison unit, and the LED of the photocoupler of the protection unit, and the secondary coil of the transmission transformer of the controller are formed at the primary ground side, and the phototransistor of the photocoupler, the inverter controller and the primary coil of the transmission transformer, the secondary coil of the first transformer, the secondary coil of the second transformer, and the rectifying/smoothing unit are formed at the secondary ground side.

10. The device of claim 8, wherein the power supply unit has a primary ground side and a secondary ground side each having a different ground potential level,
wherein the filter unit, the rectifying unit, the power factor correction unit, the switching circuit and the primary coil of the first transformer of the inverter unit, the flyback controller and the primary coil of the second transformer of the converter unit, a voltage-dividing resistor, the comparison unit, and the LED of the photocoupler of the protection unit, and the secondary coil of the transmission transformer of the controller are formed at the primary ground side, and the phototransistor of the photocoupler, the inverter controller and the primary coil of the transmission transformer, the secondary coil of the first transformer, the secondary coil of the second transformer, and the rectifying/smoothing unit are formed at the secondary ground side.

11. The device of claim 6, wherein the inverter controller provides an inverter control signal for switching the switching circuit on and off according to a fixed ON/OFF duty, and the inverter unit controls the current level of the lamp driving power according to resonance between the inductance of the first transformer, and leakage capacitance and resonant capacitance of a lamp.
